(19) United States
(12) Patent Application Publication
(10) Pub. No.: US 2016/0050292 A1
(43) Pub. Date: Feb. 18, 2016

(54) LOCAL WEB RESOURCE ACCESS

(71) Applicant: Xiaomi Inc., Beijing (CN)

(72) Inventors: Xianlin CHEN, Beijing (CN); Zheng LI, Beijing (CN); Tiejun LIU, Beijing (CN)

(73) Assignee: Xiaomi Inc., Beijing (CN)

(21) Appl. No.: 14/808,649

(22) Filed: Jul. 24, 2015

Related U.S. Application Data
(63) Continuation-in-part of application No. PCT/CN2015/074586, filed on Mar. 19, 2015.

(30) Foreign Application Priority Data
Aug. 13, 2014 (CN) CN201410398182.2

(51) Int. Cl. H04L 29/08; G06F 17/30; H04L 12/911

(52) U.S. Cl. CPC H04L 67/32; H04L 67/2842; H04L 47/783; G06F 17/30887; G06F 17/30864

(57) ABSTRACT

A router can be configured to serve web resources in response to expected web resource requests without requesting such resources from a corresponding remote web server. In an example, this functionality can be achieved by the router, wherein the router is configured to: receive a web resource access request from a terminal device, the web resource access request including a target uniform resource locator (URL); perform a search in a data structure containing a plurality of local URLs according to the target URL; identify a local URL of the plurality of URLs corresponding to the target URL according to the performed search; acquire a local version of a target web resource corresponding to the target URL from locally stored web resources according to the identified local URL; and communicate the local version of the target web resource to the terminal device.

### CROSS-REFERENCE TO RELATED APPLICATIONS

This application is a continuation-in-part of International Application No. PCT/CN2015/074586 with an international filing date of Mar. 19, 2015, which is based upon and claims priority to Chinese Patent Application No. 201410398182.2, filed on Aug. 13, 2014, the entire contents of which are incorporated herein by reference.

### TECHNICAL FIELD

The present disclosure relates to the field of communications technologies, and more particularly, to local web resource access.

### BACKGROUND

Under a wireless local area network, a terminal device can access a wide area network (such as a public network) via a router, so as to access servers of the network for different websites. A user can enter, on a browser of the terminal device, a uniform resource locator (URL) of a webpage. The router can then route and transmit the entered URL to the wide area network. The router can also return a web resource (such as a webpage) to the terminal device. The web resource is communicated to the router from a server of the wide network corresponding to the URL.

In retrieval of a web resource, the terminal device acquires the resource corresponding to the URL via the router. The web resource can be transmitted from the wide area network where the server is located to the router that can be located in a local area network, and then forwarded by the router to the terminal device. Because of a possible complex path of communication of the web resource between networks, technical problems with transmission speed and efficacy can occur due to distances of the communication and transmission control and routing complexities, for example.

### SUMMARY

The present disclosure includes web resource access methods and apparatuses.

In an example, a web resource access method can be implemented by a router. The method can include receiving a web resource access request (such as a webpage access request) from a terminal device (such as a smart phone or tablet computer). The web resource access request can include a target uniform resource locator (URL). The method can also include performing a search for a local URL (such as a URL of locally stored resources stored in a storage device of or attached to the router or stored in a storage device of a local area network associated with the router) according to the target URL (such as performing a search for a local URL corresponding to the target URL). The method can also include identifying a local URL of the plurality of local URLs corresponding to the target URL according to the performed search. For example, if the target URL corresponds to a local URL, the router can acquire a locally stored version of a target web resource corresponding to the target URL (such as a version of the target resource stored in a storage device of or attached to the router or stored in a storage device of a local area network associated with the router). For example, the acquiring of the local version of the web resource may be according to the identified local URL. The method can also include communicating the locally stored version of the target web resource to the terminal device.

In an example, a web resource access apparatus can include receiving circuitry configured to receive a web resource access request from a terminal device. The web resource access request can include a target URL. The apparatus can also include searching circuitry configured to perform a search for a local URL according to the target URL. The searching circuitry can also be configured to identify a local URL of the local URLs corresponding to the target URL according to the performed search. The apparatus can also include acquiring circuitry, configured to acquire a locally stored version of a target web resource corresponding to the target URL if the target URL corresponds to a local URL. For example, the acquiring of the locally stored version of the resource may be according to the identified local URL. The apparatus can also include communication circuitry configured to communicate the locally stored version of the target web resource to the terminal device.

In an example, a router can include a processor and memory including stored instructions executable by the processor to receive a web resource access request from a terminal device. The web resource access request can include a target URL. The memory can also include stored instructions executable by the processor to perform a search for a local URL according to the target URL. The memory can also include stored instructions executable by the processor to acquire a locally stored version of a target web resource corresponding to the target URL if the target URL corresponds to a local URL. In such an example, the locally stored version is acquired according to the local URL. The memory can also include stored instructions executable by the processor to communicate the locally stored version of the target web resource to the terminal device.

In an example, a non-transitory computer-readable storage medium can include stored instructions executable by a processor of a router to receive a web resource access request from a terminal device. The web resource access request can include a target URL. The medium can also include stored instructions executable by the processor to perform a search for a local URL of locally stored local URLs according to the target URL. The medium can also include stored instructions executable by the processor to identify a local URL of the local URLs corresponding to the target URL according to the performed search. The medium can also include stored instructions executable by the processor to acquire a locally stored version of a target web resource corresponding to the target URL if the target URL corresponds to a local URL. In such an example, the locally stored version is acquired according to the local URL. The medium can also include stored instructions executable by the processor to communicate the locally stored version of the target web resource to the terminal device.

It shall be understood that the above description and the detailed description hereinafter are only illustrative and not limiting of the present disclosure.

### BRIEF DESCRIPTION OF THE DRAWINGS

The accompanying drawings herein, which are incorporated into and constitute a part of the specification, illustrate examples consistent with the present disclosure, and together with the description, serve to explain examples of the present disclosure.

FIGS. 1 and 2 illustrate example operations associated with local accessing of web resources.

FIG. 3 illustrates an example implementation for operations described herein, such as operations described with respect to FIGS. 1 and 2.

FIG. 4 illustrates an example web resource access apparatus.

FIG. 5 illustrates another example web resource access apparatus.

FIG. 6 illustrates example obtaining circuitry of a web resource access apparatus.

FIG. 7 illustrates example frequent web browsing list acquiring circuitry of a web resource access apparatus.

FIG. 8 illustrates example first storing circuitry of a web resource access apparatus.

FIG. 9 illustrates another example web resource access apparatus.

FIG. 10 illustrates example second storing circuitry of a web resource access apparatus.

FIG. 11 illustrates example acquiring circuitry of a web resource access apparatus.

FIG. 12 illustrates an example electronic device configurable to implement one or more of the web resource access apparatuses described herein.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terminology used in the present disclosure is for the purpose of describing exemplary embodiments only and is not intended to limit the present disclosure. As used in the present disclosure and the appended claims, the singular forms “a”, “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first”, “second”, “third”, etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

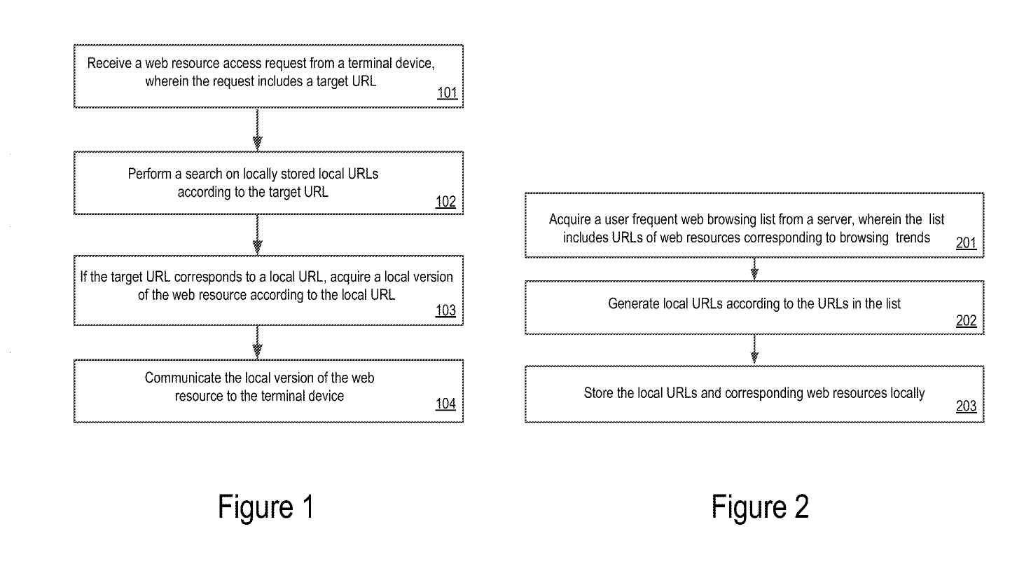

FIG. 1 illustrates example operations associated with accessing of web resources. A router can implement these operations. In operation 101, the router from a terminal device receives a web resource access request. The web resource access request can include a target URL. The router can be a smart router device in that in addition to its routing features, it can include at least an independent operating system, processor, and a data storage device. The terminal device may be any end user device, such as any smart device having Internet access features. For example, the terminal device may be a mobile phone, a tablet computer, or a personal digital assistant (PDA), for example. The terminal device may access the router via a wireless local area network, and access servers of a wide area network (such as a public network) via the router.

A URL can provide of a location and an access method for obtaining a resource over the Internet. Each web resource on the Internet can have a unique URL. A web resource access request that includes a URL can be communicated from the terminal device to the router. Such a request can include or be a Hypertext Transfer Protocol (HTTP) request.

In operation 102, a search is performed in a data structure containing stored local URLs, according to the target URL. The search may identify a local URL of the local URLs corresponding to the target URL. The router may store local URLs upon obtaining the local URLs derived from URLs of web resources corresponding to access trends of terminal device users or their devices. During generation of the local URLs, the router may obtain a frequent web browsing list from a server. The server may be a server configured on a wide area network and configured for web resource preloading analysis. The server may generate frequent web browsing lists for different routers according to predetermined strategies. The frequent web browsing lists can include the URLs of the web resources corresponding to access trends of terminal device users or their devices.

Upon receiving a web resource access request from a terminal device, the router may perform a search in a data structure containing the local URLs according to the target URL included in the web resource access request, so as to determine whether the local version of the target URL can be identified in a data structure containing the local URLs. For example, a data processor of the router may identify a local URL of the local URLs corresponding to the target URL according to the performed search.

In operation 103, if a local URL corresponding to the target URL is identified in the data structure containing the local URLs by the search, a local version of the target web resource is acquired from locally stored web resources according to the identified local URL. For example, after a local version of the target URL is identified in a data structure containing the local URLs, the router can indicate to the terminal device that the target web resource has been locally stored. Therefore, the target web resource may be directly acquired from local storage instead of over a wide area network from the server hosting the target resource. In operation 104, the target web resource is communicated to the terminal device.

By storing the local URLs and the local web resources on the router or a device attached to the router, when the target URL included in the web resource access request communicated by the terminal device is identified in a data structure containing the local URLs, the target web resource corresponding to the target URL may be acquired from the local web resources and communicated to the terminal device. Since the router may directly return a locally stored web resource to the terminal device, without acquiring the web resource from the server according to the target URL, the time elapsed when the target web resource is transmitted over a wide area network from the server is saved. Thus, the speed of obtaining the target web resource by the terminal device is increased.

FIG. 2 illustrates other example operations associated with accessing of web resources. These operations may be performed by a router and in addition to the operations of FIG. 1. In operation 201, a frequent web browsing list is acquired from a server. The frequent web browsing list can include URLs of web resources corresponding to access trends of terminal device users. The router can then act like a smart device (such as in the capacity of a smart router). Besides routing functions, such as switching and forwarding functions, the router can also include an independent operating system and memory and data storage capacities to store web resources and corresponding local URLs.

The server in these examples may reside within a wide area network (such as a public network) and may be configured for web resource preloading analysis. The server may generate frequent web browsing lists for different routers according to predetermined strategies based on a machine learning algorithm. The frequent web browsing list includes URLs of web resources corresponding to web browsing trends of terminal device users (such as trends based on routines of the user or the terminal device itself). The server can also store corresponding relationships between router identifiers and frequent web browsing lists. A router identifier may be a media access control (MAC) address of the router. The URLs of the web resources corresponding to the browsing trends of the terminal device users may include URLs of web resources accessed by terminal device users accessing the network via a specific router. The trends may also include URLs of web resources about frequently browsed topics on a social networking platform, for example. The trends may also include URLs of several frequently visited portal websites.

In an example, when the router is powered on and its operating system is activated, the frequent web browsing lists can be acquired by the router from the server. Since the frequent web browsing lists on the server may be subsequently updated, the router may acquire the frequent web browsing lists from the server according to a schedule, to at least partially synchronize the frequent web browsing lists on the router with the frequent web browsing lists on the server.

With respect to the acquisition of the frequent web browsing lists, the router can communicate a corresponding list acquisition request to the server. The list acquisition request can include a first router identifier of the router. The server can perform a search in a data structure containing corresponding relationships between the router identifiers and URLs in the frequent web browsing lists according to at least the first router identifier. The server can communicate the searched frequent web browsing list corresponding to the first router identifier to the router according to the search.

Also, if the computation and processing capabilities of the router are sufficient, the router may determine by itself the browsing trends of a terminal device or its users according to specific strategies, and locally generate the frequent web browsing lists without out the storage and processing resources of a separate server.

In operation 202 illustrated in FIG. 2, local URLs are generated according to the URLs in the frequent web browsing list. For example, upon receiving a frequent web browsing list, the router parses the frequent web browsing list to obtain URLs contained therein, and generates the local URLs according to the URLs in the list. Also, according to different formats of the frequent web browsing list, different parsing techniques may be employed to parse the frequent web browsing list.

In operation 203, the local URLs and the corresponding resources are stored locally. The corresponding resources can be received and/or retrieved by the router from corresponding servers. In an example, the router may store the local URLs into a data structure on a local storage medium, such as a disk drive. The router may be preconfigured to perform the operation for storing the local URLs into the data structure on the disk drive. The data structure may be a database and each of the URLs may correspond to one data record in the database. To prevent the local storage resources from being fully occupied, a data removal schedule may be implemented by the router to remove saved URLs (such as stored URLs that have been inactive beyond a threshold period of time). The router may periodically check the age and/or frequency of access of a stored URL according to a schedule, and remove a URL according to its age and/or frequency of access. Also, through the synchronization with the server, invalid local URLs may be removed as well. For example, if a corresponding URL does not exist on the server, the local URL may be considered invalid by the router and removed from storage. Also, since the local URLs are stored in a disk or other type of permanent data storage device, the router can be safeguarded with respect to its list of URLs and web resources from power failures or shutting down of the router.

In an example, the router may cache the local URLs into a memory assigned to a kernel. The router may preconfigure an application to implement communication between an application layer and a kernel layer. The application may employ a kernel interface, such as a Netlink Socket mechanism, and notify the server of each URL obtained by parsing the user frequent web browsing list through the kernel. The kernel can store the URLs into memory assigned to the kernel. With respect to each URL, after a web resource corresponding to a URL is successfully downloaded to become a local web resource of the router, the URL may be subsequently communicated to an active cache of the kernel. Since the speed at which the kernel accesses the cache memory is higher than the speed of accessing a disk or permanent storage device (such as a hard drive), the speed of searching for the local URL may be increased by caching the local URLs via the kernel.

Also, the local web resources corresponding to the local URLs may be stored by the router. This may occur upon downloading the web resources from their respective web servers found over the Internet. The router can generate a local storage address for each web resource corresponding to each URL. The local storage address may be identified by using a hash value for the local URL corresponding to a web resource and the resource's path in the local storage structure (such as a complete path including the root storage directory of the web resource). For example, assume that the web resource storage root directory on the router is “/cache/data” and the hash value of the URL is “ADKEOCOWENLFOJFSELINXO3234%2DS”, the corresponding local storage address could be “/cache/data/ADKEOCOWENLFOJFSELINXO3234%2DS”. The router can store each web resource into a local disk or even cache memory according to the local storage address of each web resource.

Also, besides removing a data record corresponding to an expired URL from a storage device of the router, records can also be removed from memory assigned by a kernel of the router. Also, storage and/or cache space of the URL and the corresponding web resource can also be cleared, so that the removal of the URL and the resource are synchronized. Also, when the memory designated by the kernel temporarily stores the local URLs, upon receiving a web resource access request from a terminal device, the router may hijack the web resource access request by using a kernel protocol stack to obtain the target URL, and perform a search in a data structure containing the local URLs stored in the memory according to the target URL. This is to determine whether the target URL can be identified in the local data structure containing the local URLs.

Where a target URL is identified in a data structure containing the local URLs, it indicates that the local disk or cache of the router stores a target web resource corresponding to the target URL. In such a case, the kernel of the router may communicate the searched target URL to a designated port monitored by a web service in the router. For example, when the web service is specifically a proxy service, such as “nginx”, the port may be designated (e.g., the designated port may be the port “80”). Where the web service is monitored, the target URL at the designated port, being consistent with a protocol for determining the local storage address during storing of the local web resource (such as in an example of operation 102 in FIG. 1), the local storage address of the target web resource may be determined according to a hash value of the target URL and a web resource storage path. The target web resource may be acquired from the local disk according to the local storage address, such that the server directly communicates the locally stored target web resource to the terminal device. As such, web resource access of the terminal device is implemented within a local area network.

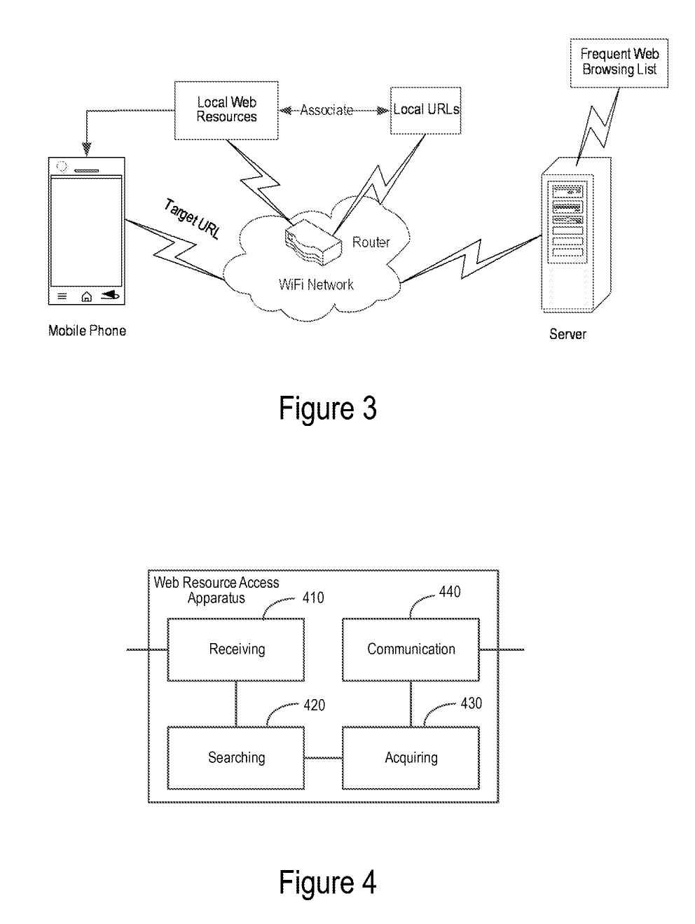

FIG. 3 illustrates an example implementation for operations described herein, such as operations described with respect to FIGS. 1 and 2. For example, FIG. 3 illustrates a mobile phone, a router, and a server. The mobile phone accesses the router via a LAN WiFi network, and the router is connected to the server in a wide area network (such as a public network). The terminal device in this example is a mobile phone. Yet, in other examples, the terminal device may be any terminal device capable of accessing web resources, such as a laptop computer or a tablet computer. Also, the terminal device and the router may be connected either via any type of wireless network or via a wired network capable of communicating web resources.

With respect to FIG. 3, the server can maintain a frequent web browsing list. The router can acquire target URLs according to the frequent web browsing list. Also, the router can generate corresponding local URLs and download the corresponding web resources according to the local URLs. Each URL of the local URLs can correspond to one web resource of downloaded local web resources. When a terminal device user inputs a target URL of a target web resource, the terminal device can transmit the target URL to the router via a local area network (such as the illustrated WiFi network). Also, when searching out the target URL in a data structure containing the local URLs, the router may directly acquire a target web resource corresponding to the target URL from the local web resources, and communicate the local version of the target web resource to the terminal device.

FIG. 4 illustrates an example web resource access apparatus. The apparatus includes receiving circuitry 410, searching circuitry 420, acquiring circuitry 430, and communication circuitry 440. The receiving circuitry 410 is configured to receive a web resource access request from a terminal device. The web resource access request can include a target URL. The searching circuitry 420 is configured to perform a search in a data structure containing local URLs, according to the target URL. The acquiring circuitry 430 is configured to acquire a local version of the target web resource corresponding to the target URL, if the target URL is identified in the data structure. The communication circuitry 440 is configured to communicate the acquired local version of the web resource to the terminal device.

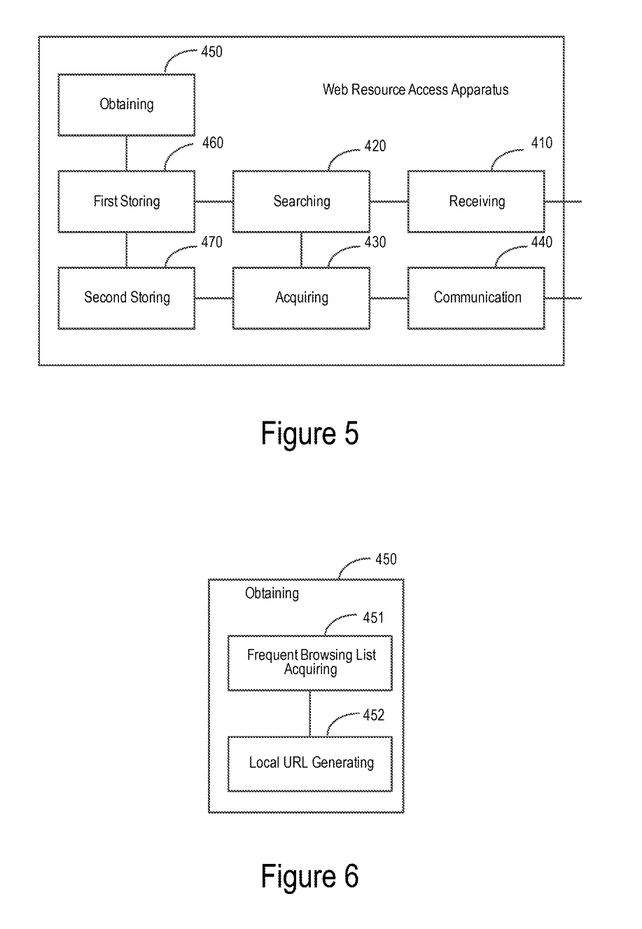

FIG. 5 illustrates another example web resource access apparatus. This example is based on the apparatus illustrated in FIG. 4, and includes additional circuitries. The additional circuitries include obtaining circuitry 450, first storing circuitry 460, and second storing circuitry 470. The obtaining circuitry 450 is configured to obtain the local URLs. The local URLs including at least one URL of a web resource corresponding to an online resource access trends of a terminal device or a user of the terminal device. The first storing circuitry 460 is configured to store the local URLs. The second storing circuitry 470 is configured to store local versions of the corresponding web resources.

FIG. 6 illustrates example obtaining circuitry of a web resource access apparatus, such as the apparatus of FIG. 5. The obtaining circuitry 450 may include frequent web browsing list acquiring circuitry 451 and local URL generating circuitry 452. The frequent web browsing list acquiring circuitry 451 is configured to acquire a frequent web browsing list from a server. The frequent web browsing list including at least one URL of the web resource corresponding to a web resource access trends of the terminal device or a user of the terminal device. The at least one URL can be generated by the server according to a predetermined strategy, such as criteria for determining the web resource access trends. The local URL generating circuitry 452 is configured to generate the local URLs by parsing URLs in the frequent web browsing list.

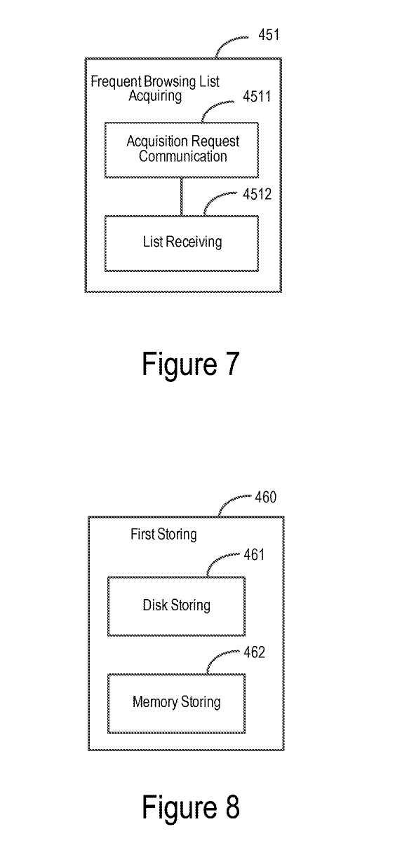

FIG. 7 illustrates example frequent web browsing list acquiring circuitry of a web resource access apparatus, such as the frequent web browsing list circuitry of FIG. 6. The frequent web browsing list acquiring circuitry 451 may include acquisition request communication circuitry 4511 and frequent web browsing list receiving circuitry 4512. The acquisition request communication circuitry 4511 is configured to communicate a frequent web browsing list acquisition request to the server according to a first schedule. The frequent web browsing list acquisition request can include a first router identifier, a relationship between corresponding router identifiers and the frequent web browsing lists stored on the server. The frequent web browsing list receiving circuitry 4512 is configured to receive a frequent web browsing list corresponding to the first router identifier from the server after the server performs a search in a data structure containing the corresponding relationship. The frequent web browsing list may be acquired from the server according to a schedule.

FIG. 8 illustrates example first storing circuitry of a web resource access apparatus, such as the first storing circuitry of FIG. 5. The first storing circuitry 460 may include disk storing circuitry 461 and/or memory storing circuitry 462. The disk storing circuitry 461 is configured to store the local URLs into a data structure (such as a database) stored on a local hard disk. The memory storing circuitry 462 is configured to cache the local URLs into a memory assigned to a kernel.

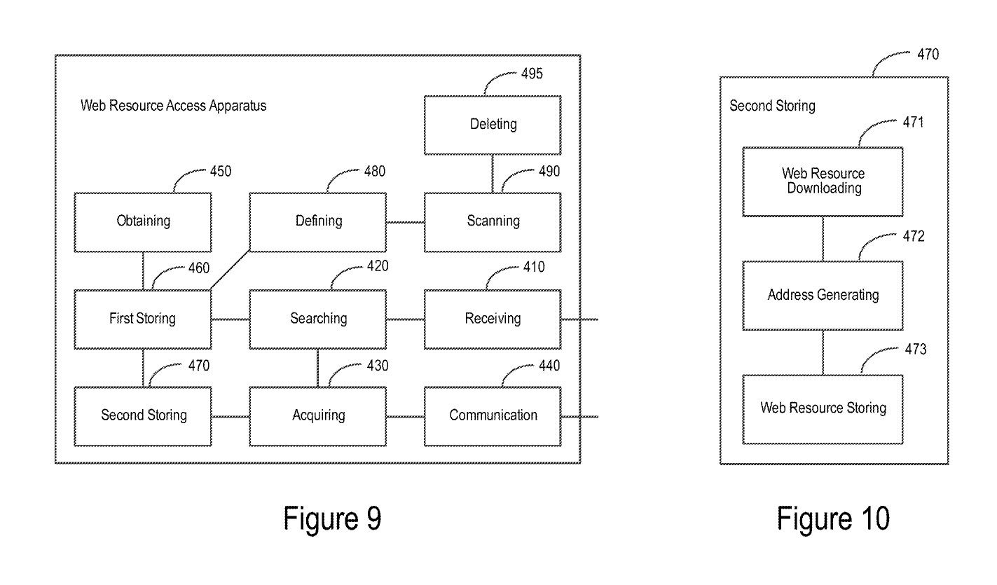

FIG. 9 illustrates another example web resource access apparatus. This example of the apparatus is based on the example apparatus as illustrated in FIG. 5, but also includes defining circuitry 480, scanning circuitry 490, and deleting circuitry 495. The defining circuitry 480 is configured to define a life for each URL in a data structure containing the local URLs. The scanning circuitry 490 is configured to scan the lives of the URLs in the local storage according to a second schedule. The deleting circuitry 495 is configured to delete, according to a result of the scanning, URLs whose lives have expired, and delete the corresponding local versions of web resources.

FIG. 10 illustrates example second storing circuitry of a web resource access apparatus, such as the second storing circuitry 470 as illustrated in FIGS. 5 and 9. The second storing circuitry 470 may include a web resource downloading circuitry 471, a storage address generating circuitry 472, and a web resource storing circuitry 473. The web resource downloading circuitry 471 is configured to download a web resource corresponding to each URL of the at least one URL from a server. The storage address generating circuitry 472 is configured to generate a local storage address of each web resource corresponding to each URL. The local storage address can be identified by using a hash value of a URL corresponding to the web resource and a web resource storage path, such as the path from a root directory. The web resource storing circuitry 473 is configured to store the each web resource into a local disk according to the local storage address of each web resource.

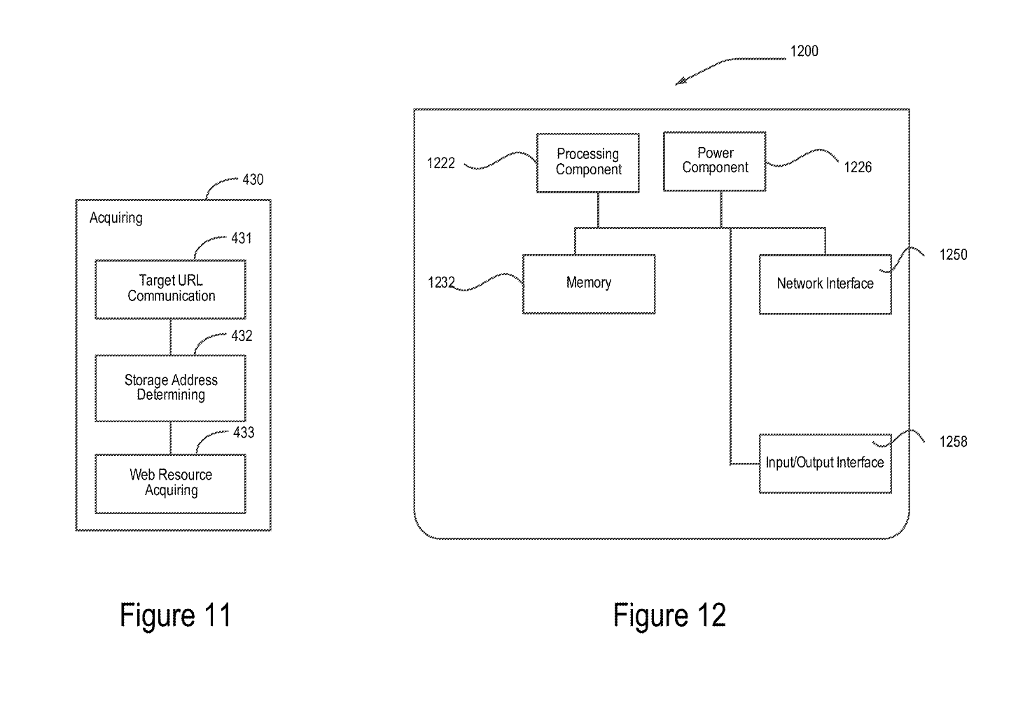

FIG. 11 illustrates example acquiring circuitry of a web resource access apparatus, such as the acquiring circuitry 430 as illustrated in FIGS. 4, 5, and 9. The acquiring circuitry 430 may include a target URL communication circuitry 431, a storage address determining circuitry 432, and a web resource acquiring circuitry 433. The target URL communication circuitry 431 is configured to communicate the target URL to a designated port monitored by a web service. The storage address determining circuitry 432 is configured to determine a local storage address of the target web resource according to a hash value of the target URL and the web resource storage path, when the web service has monitored the target URL at the designated port. The web resource acquiring circuitry 433 is configured to acquire the target web resource from the local disk according to the local storage address of the target web resource.

FIG. 12 illustrates an example electronic device 1200 configurable to implement one or more of the web resource access apparatuses described herein. For example, the electronic device 1200 may be a router. The electronic device 1200 includes a processing component 1222, which can include one or more processors. The electronic device 1200 can also include memory and data storage resources represented by memory 1232. The memory 1232 can be configured to store instructions executable by the processing component 1222. Most of the circuitries described herein may be replaced by respective instructions of the memory 1232.

The electronic device 1200 includes a power component 1226, configured to perform power management in the electronic device 1200. The electronic device 1200 also includes a wired or wireless network interface 1250, configured to connect the electronic device 1200 to a corresponding network. The electronic device 1200 also includes an input/output (I/O) interface 1258. The electronic device 1200 may operate an operating system stored in the memory 1232, for example, WINDOWS SERVER, MAC OS X, UNIX, LINUX, or FREEBSD, for example.

The technical solutions provided in these examples may overcome several technical problems. For example, by locally storing local URLs and web resources in memory of a router, when the target URL included in the web resource access request is identified in a data structure containing the local URLs, the target web resource corresponding to the target URL may be acquired from the local web resources and communicated to the terminal device. Since the router may return a locally stored web resource from within a local area network to the terminal device, with no need of acquiring the web resource from a corresponding server over a wide area network, communication time is reduced. Thus, for example, at least the speed of obtaining the target web resource by the terminal device is increased, such that the terminal device user can more quickly browse the target web resource. Additionally, besides an increase in speed, the efficacy of the web resource and the transport of the resource may be improved.

Also, the terminal device or router may receive a frequent web browsing list that can include a URL of a web resource that the terminal device or the device user frequently requests from the server. The server may generate such a list according to a plurality of predetermined strategies, so as to ensure that the URLs are capable of covering, to a preset probability, the URLs that the terminal device or the user of the device frequently requests. In an example, the frequent web browsing list may be acquired from the server periodically according to a predetermined schedule. The schedule of the acquiring of the list may be set according to the frequency of updates to the list.

Also, local URLs may be stored at different locations of the router. The local URLs may be stored at a local hard disk drive of or connected to the router. This safeguards the local URLs when the router is powered down. In an example, a life may be defined for each URL, such that when the life expires, the URL and web resource are deleted. This last feature can prevent the local hard disk drive or other type of local storage device from being completely used. The URLs can also be stored temporarily in memory assigned by a kernel of the router, which can speed up the search for the local URLs.

Other embodiments of the present disclosure will be apparent to those skilled in the art from consideration of the specification and practice disclosed herein. This application is intended to cover any variations, uses, or adaptive variations of the present disclosure following the general principles thereof and including such departures from the present disclosure as coming within common knowledge or customary technical means in the art. It is intended that the specification and embodiments be considered as exemplary only.

It will be appreciated that the present disclosure is not limited to the exact construction that has been described above and illustrated in the accompanying drawings, and that various modifications and changes can be made without departing from the scope thereof.

What is claimed is:

1. A method, comprising:
receiving, at a router, a web resource access request from a terminal device, the web resource access request including a target uniform resource locator (URL);
performing, by a processor of the router, a search in a data structure containing a plurality of local URLs according to the target URL, the data structure stored in a storage device of the router, and the plurality of local URLs derived from web browsing trends;
identifying, by the processor, a local URL from among the plurality of URLs corresponding to the target URL according to the performed search;
acquiring, by the processor, a local version of a target web resource corresponding to the target URL from locally stored web resources according to the identified local URL, the locally stored web resources stored in the storage device of the router; and
communicating, by the router, the local version of the target web resource to the terminal device.

2. The method of claim 1, further comprising receiving, by the router, a trend data structure identifying the web browsing trends, in response to communicating a corresponding request to a server hosting the trend data structure.

3. The method of claim 2, wherein the receiving of the trend data structure and the communicating of the corresponding request occur over a wide area network.

4. The method of claim 1, further comprising downloading, by the router, web resources corresponding to the web browsing trends.

5. The method of claim 4, wherein the downloading is according to a predetermined schedule set on the router.

6. The method of claim 4, wherein the downloading occurs over a wide area network.

7. The method of claim 1, further comprising deriving, by the processor, the plurality of local URLs from web browsing trends of the terminal device.

8. The method of claim 1, further comprising deriving, by the processor, the plurality of local URLs from web browsing trends of a social network product.

9. The method of claim 1, wherein each of the plurality of the local URLs includes a respective hash value corresponding to a respective web resource and a storage path of the respective web resource.

10. The method of claim 1, further comprising:
running, by the processor, a kernel on the router;
assigning cache memory to cache the plurality of local URLs according to the kernel; and
caching the plurality of local URLs during the performing of the search.

11. A router, comprising:
receiving circuitry configured to receive a web resource access request from a terminal device, the web resource access request including a target uniform resource locator (URL);
search circuitry configured to:
perform a search in a data structure containing a plurality of local URLs according to the target URL, the data structure stored in a storage device of the router, and the plurality of local URLs derived from web browsing trends; and
identify a local URL from among the plurality of URLs corresponding to the target URL according to the performed search;
acquiring circuitry configured to acquire a local version of a target web resource corresponding to the target URL from locally stored web resources according to the identified local URL, the locally stored web resources stored in the storage device of the router; and
communication circuitry configured to communicate the local version of the target web resource to the terminal device, via a local area network.

12. The router of claim 11, further comprising obtaining circuitry configured to receive a trend data structure identifying the web browsing trends, in response to the router communicating a corresponding request to a server hosting the trend data structure.

13. The router of claim 12, wherein the obtaining circuitry is configured to receive the trend data structure over a wide area network.

14. The router of claim 11, further comprising deriving circuitry configured to derive the plurality of local URLs from the web browsing trends, the web browsing trends including web browsing trends of the terminal device, a user of the terminal device, or a social network product.

15. The router of claim 11, wherein each of the plurality of the local URLs includes a respective hash value corresponding to a respective web resource and a storage path of the respective web resource.

16. The router of claim 11, further comprising operating system circuitry, configured to:
run a kernel on the router;
assign cache memory to cache the plurality of local URLs according to the kernel; and
cache, in the cache memory, the data structure containing the plurality of local URLs during a search for a local URL.

17. A non-transitory computer-readable storage medium, comprising:
instructions executable by a processor of a router to receive a web resource access request from a terminal device, the web resource access request including a target uniform resource locator (URL) for a target web resource hosted at a server of a wide area network;
instructions executable by the processor to perform a search in a data structure containing a plurality of local URLs according to the target URL, the data structure stored in a storage device of the router, and the plurality of local URLs derived from web browsing trends;
instructions executable by the processor to identify a local URL from among the plurality of URLs corresponding to the target URL according to the performed search;
instructions executable by the processor to acquire a local version of the target web resource corresponding to the target URL from locally stored web resources according to the identified local URL, the locally stored web resources stored in the storage device of the router; and
instructions executable by the processor to communicate the local version of the target web resource to the terminal device, via a local area network.

18. The non-transitory computer-readable storage medium of claim 17, further comprising instructions executable by the processor to receive a trend data structure identifying the web browsing trends, in response to the router communicating a corresponding request to a server hosting the trend data structure.

19. The non-transitory computer-readable storage medium of claim 17, wherein each of the plurality of the local URLs includes a respective hash value corresponding to a respective web resource and a storage path of the respective web resource.

20. The non-transitory computer-readable storage medium of claim 17, further comprising:
instructions executable by the processor to run a kernel on the router;
instructions executable by the processor to assign cache memory to cache the plurality of local URLs according to the kernel; and
instructions executable by the processor to cache, in the cache memory, the data structure containing the plurality of local URLs during a search for a local URL.
